(19) United States
(12) Patent Application Publication
(10) Pub. No.: US 2006/0155929 A1
(43) Pub. Date: Jul. 13, 2006

(54) Storage medium with reserved area for file system data and application start-up data

(75) Inventors: Declan Patrick Kelly, Eindhoven (NL); Wilhelmus Franciscus Johannes Fontijn, Eindhoven (NL); Wilhelmus Jacobus Van Gestel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.V.

(21) Appl. No.: 10/545,183

(22) PCT Filed: Jan. 28, 2004
(86) PCT No.: PCT/IB04/00319

§ 371 Date: Aug. 9, 2005

(30) Foreign Application Priority Data
Feb. 12, 2003 (EP) 03290345.2

(51) Int. Cl. G06F 13/00

(52) U.S. Cl. 711/113

(57) ABSTRACT

According to a first aspect of the invention, data that will be needed for starting the applications of the storage medium are stored in a reserved area of the storage medium. The data stored in the reserved area are read and cached in a single operation when the storage medium is declared to the operating system. Therefore the seeking and spinning-up operations of the reading head that are required for starting the application(s) are limited to a minimum. According to a second aspect of the invention, programs that create a new application file indicate whether this application file should be assigned to the reserved area. If so, the file system implementation allocates the application file to the reserved area.

### FIELD OF THE INVENTION

The present invention relates to the field of data storage. More specifically it relates to a storage medium storing data organized in files complying with a file system usable under an operating system, said data including file system data and application data. It also relates to a method of manufacturing such a storage medium.

The invention also relates to a device for executing an application by reading data stored on a storage medium and to a device for writing files on a storage medium.

More specifically it relates to an apparatus comprising means for storing and executing an operating system and a file system implementation program that implements a file system usable under said operating system, and means for reading and/or writing data from and/or onto a storage medium declared to said operating system under the control of said file system implementation program.

The invention also relates to a file system implementation program implementing such a file system.

The invention also relates to an application program having instructions for generating an application file intended to be used by an application, said application file being compliant with a file system usable under an operating system, in an apparatus for reading and/or writing data from/onto a storage medium declared to said operating system.

The invention permits of reducing start-up time as well as power consumption. It applies advantageously to both stationary and portable devices.

### BACKGROUND OF THE INVENTION

The German patent application DE4127518 describes a system comprising a magnetic storage unit having a start-up area for storing start-up data that are needed for starting the system. This start-up area is read and stored in a memory as soon as the system is biased in order to reduce the system start-up time.

The start-up data mentioned in this prior art are parameters needed for starting the system.

One of the objects of the invention is to optimize the storage of data on a storage medium so as to reduce the access time and the power consumption for such access.

### SUMMARY OF THE INVENTION

This is achieved with:

a storage medium as claimed in claims 1 to 4,

a device for executing an application by reading application data stored on a storage medium as claimed in claim 5,

a device for writing a file on a storage medium as claimed in claim 6,

a method of manufacturing a storage medium as claimed in claim 7,

a file system implementation program implementing a file system as claimed in claim 8, and an apparatus as claimed in claim 9 comprising means for storing and executing such a file system implementation program,

an application program having instructions for generating an application file as claimed in claim 10, and an apparatus as claimed in claim 11 comprising means for storing and executing such an application program.

The invention takes into consideration the fact that a storage medium carries many types of data that have to be read before being able to start an application, in addition to the system start-up data dealt with in the above-mentioned prior art.

The storage medium of the invention is compatible with a certain file system. It stores data including file system data and application data. The file system data describe the storage medium as a whole and the individual files stored on the storage medium. The file system data are to be read on start-up. The application data are data that are used for executing an application. Part of the application data may be needed to start the application. According to the invention an area is reserved on the storage medium to store the file system data as well as the application data that are needed to start an application (to the extent that there is enough space in the reserved area). This reserved area is read and cached automatically when the storage medium is declared to the operating system. The invention makes it possible to gather in a single area of the storage medium the data that will be needed for starting the application(s) for which the storage medium carries data. The data stored in the reserved area are read in a single operation when the storage medium is declared to the operating system. Therefore the seeking and spinning-up operations of the reading head that are required for starting the application(s) are limited to a minimum. This leads to savings in time and power consumption.

Usually data storage is done along a spiral having an inner part and an outer part. Depending on the reading technology used by the reading device, and depending on the amount of data that will be stored in the reserved area, it may be optimum to locate the reserved area in the inner part or in the outer part of the storage medium.

For example if the reading device uses Constant Angular Velocity, the difference in bitrate between inner and the outer parts is approximately two. This means that reading a same amount of data in the outer part takes half the time and half the power it takes in the inner part. But in existing devices, when the storage medium is inserted in the reading device, the reading head always starts at the inner part. Therefore locating the reserved area in the outer part of the storage medium will require a maximum seeking time. It may be seen from the above, that it is advantageous for CAV to locate the reserved area in the outer part if the amount of data to be stored in the reserved area is large enough.

In a first embodiment of the invention, the location of the reserved area is predetermined.

In a second embodiment of the invention, the location of the reserved area is indicated by storing an anchor in a specific zone in the inner part of the storage medium. The specific zone where the anchor is stored may be a predetermined position in the inner part of the storage medium. Alternatively, it may be a known address range wherein the structure comprising the anchor is identified by a characteristic header (for instance the Disc Navigation area DN). In this second embodiment, the location of the reserved area may vary from one storage medium to another.

The size of the reserved area may either be predetermined or may vary from one storage medium to another. When not predetermined, the size of the reserved area is advantageously stored together with the anchor in the inner part of the storage medium.

According to another aspect of the invention, the file system defines a specific category of files to be allocated to the reserved area of said storage medium whenever possible. When an application program generates an application file that is intended to be used for starting an application, it assigns this application file to said specific category. The file system implementation program is designed so as to recognize files assigned to said specific category and to try and allocate such files to the reserved area. In practice such files will be allocated to the reserved area if the remaining space in the reserved area is sufficient.

### BRIEF DESCRIPTION OF THE DRAWINGS

The present invention will be described by way of non-limitative exemplary embodiments, illustrated in the accompanying drawings in which:

FIG. 1 is a schematic representation of an example of a storage medium,

FIG. 2 is a representation of the organization of data in a storage medium,

FIG. 3 is an example of data organisation in a storage medium according to the invention,

FIG. 4 is a schematic functional representation of a device according to the invention for reading and/or writing data from and/or onto a storage medium according to the invention,

FIG. 5 is a hardware block diagram of a device according to the invention,

FIG. 6 is a block diagram representing the steps implemented by an application program and a file system implementation program according to the invention, when said programs are executed by a microprocessor.

### DESCRIPTION OF PREFERRED EMBODIMENTS

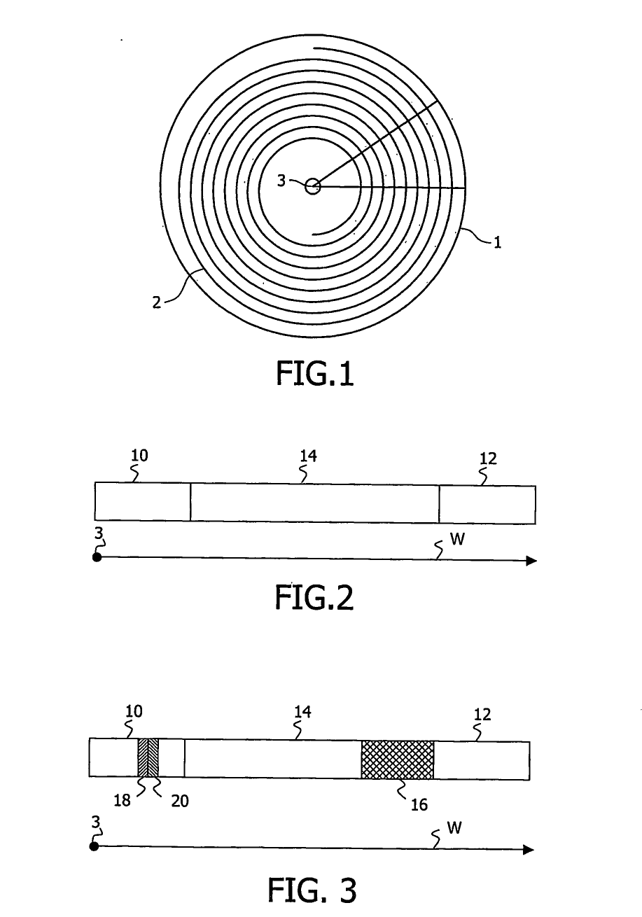

The storage medium represented in FIG. 1 is an optical disc 1. Data are written on the disc 1 along a spiral 2 starting from the centre 3 of the disc.

FIG. 2 shows how data are organized on the disc. The arrow W indicates the spiral reading direction. The disc comprises an information zone commonly divided into three zones referred to as lead-in zone, data zone, and lead-out zone. The lead-in zone 10 is the innermost zone of the information zone. The lead-out zone 12 is outermost zone of the information zone. The data zone 14 is located between the lead-in zone and the lead-out zone.

The lead-in zone 10 comprises start-up data that are read after the disc has been inserted into the reading device. Basically these start-up data are control data needed by the reading device to operate (for instance data for adjusting the equalizer of the reading device, information about the disc such as disc category, disc size, disc structure, recording density, . . . ).

The lead-out zone 12 stores data needed for smooth read-out.

The data zone 14 contains the main data, notably the file system data and the application data.

The file system data are all the data descriptive of the file structure of the disc and of the individual files stored on the disc. The file system data are read after the data of the lead-in zone after the disc has been inserted into the reading device.

The application data are all the data that are needed for executing an application. Part of the application data may be needed for starting an application. These application data are called application start-up data. They are read as soon as the application starts, before the control may be handed to the user. When a certain application is associated with a particular disc (for instance a video playing application) the application start-up data are usually read after the disc has been inserted into the reading device immediately after the data of the lead-in zone and after the file system data.

By way of example, the application start-up data may be a menu, registered video playback settings, a table of contents, a specific browser, Digital Right Management data used for controlling user rights, etc. . . .

An area 16 is reserved in the data zone 14. The file system data and the application start-up data are stored in this reserved area 16.

The location of the reserved area in the data zone depends on the following factors:

a) the technology used for reading data on the disc;

b) the quantity of data to be stored in the reserved area.

Reading data on the disc includes: spinning-up of the disc, seeking the location to be read, and reading the data.

When the disc has been inserted into the reading device, the reading head starts reading the lead-in area. Thus, it is advantageous in principle to locate the reserved area 16 in the innermost part of the data zone in order to limit seeking operations.

However, the quantity of data stored in a given angular sector is smaller at the centre of the disc than at the periphery. This means that, if the disc is spun up with a constant angular velocity (CAV), the time and power required for reading a same quantity of data decreases as the distance to the centre of the disc increases. This means that beyond a certain size the reserved area is preferably located in the outermost part of the data zone in the case of CAV.

The location of reserved area 16 may be a predetermined fixed location. If the location of the reserved area is not predetermined, an anchor 18 pointing to the reserved area is stored in a specific zone, preferably in the inner part of the disc. This anchor is stored, for example, in the lead-in zone 10.

The size of the reserved area may be fixed or may vary, depending on the disc. If not predetermined, the size 20 of the reserved area 16 is stored in a specific zone preferably together with the anchor in the inner part of the disc.

An example is illustrated in FIG. 3. In FIG. 3, the reserved area 16 is located in the outermost part of the data zone. The anchor 18 and the size 20 of the reserved area 16 are stored in the lead-in zone 10.

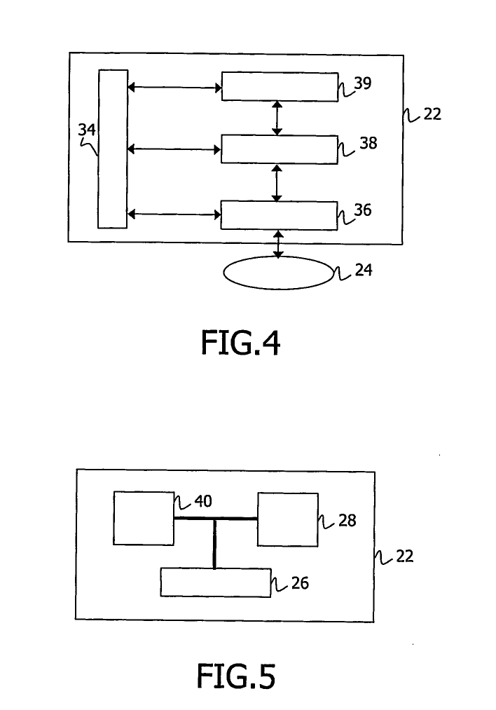

FIG. 4 is a functional block diagram of a device 22 according to the invention for reading and/or writing data from/onto a disc 24 of the type described above with reference to FIGS. 1 to 3. FIG. 5 is a hardware block diagram of the same device 22. As shown in FIG. 5, the device 22 comprises an optical unit 26 for reading/writing data from/onto the disc 24. The disc 24 is compliant with a certain file system. The device 22 comprises memory means 28 for storing an operating system 34, a disc driver 36, a file system implementation program 38, and at least one application program 39. The device 22 also comprises processing means 40 for executing these programs. The disc driver 36, the file system implementation program 38, and the application programs are usable under the operating system 34. The disc driver 36 is responsible for controlling the access (in reading and/or in writing) to the disc 24. The file system implementation program 38 is responsible for implementing the file system. The application program 39 is responsible for executing an application.

According to a first aspect of the invention, the driver 36 is designed so as to read and cache the data stored in the reserved area when a disc is declared to the operating system 34 (which is usually done automatically when a disc is inserted into the optical unit 26). The data may be cached either in the optical unit 26 or in the memory means 28.

According to another aspect of the invention, the file system notably defines a specific file category, called start-up category, for the files that should be allocated to the reserved area.

Application programs are designed such that when generating a new application file that is needed for starting an application, they assign this new application to this start-up category.

The file system implementation program 38 comprises instructions for identifying the files that belong to this specific category, and for trying to allocate such files to the reserved area when writing a file onto the disc. As a result, newly created application start-up files are assigned to the start-up category so that they are automatically allocated to the reserved area, to the extent that there is enough space in the reserved area.

Similarly files that are assigned to the start-up category will be allocated to the reserved area during the disc manufacturing process.

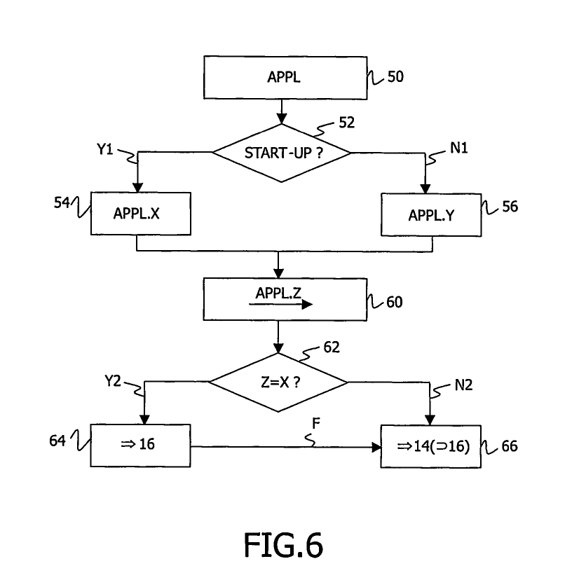

These processes are illustrated in FIG. 6.

Boxes 50 to 56 describe an application file creation process. In box 50 an Application program creates a new application file APPL. In box 52 the Application program decides whether or not the file APPL is needed for starting an application. If the answer is yes (arrow Y1), the Application program transmits the application file APPL to the File System implementation program (box 54) together with an indication that the application is assigned to the start-up category (this may be indicated in the name of the application file; in the example described here it is indicated by the extension X of the name of the application file APPL.X; this example is not restrictive). If the answer is no (arrow N1), the Application program transmits the application file APPL to the File System implementation program (box 56) together with an indication that the application is not assigned to the start-up category (for instance, this may be indicated by using no extension at all or by using an extension Y that is different from the extension X mentioned above).

Boxes 58 to 66 describe a file allocation process. In box 60, the File System implementation program receives a file APPL to be allocated to the data zone of the disc. In box 62, the File System implementation program checks whether the file is assigned to the start-up category (for instance by checking the extension of the name of the file). If the file is assigned to the start-up category (arrow Y2), the File System implementation program tries to allocate the file APPL to the reserved area 16 (box 64). If there is enough space in the reserved area, the allocation is successful and the process terminates. If there is not enough space in the reserved area (arrow F), or if it was decided in box 62 that the file was not assigned to the start-up category (arrow N2), then the File System implementation program allocates the application file APPL in any other area of the data zone (box 66).

Modifications or improvements may be proposed with respect to the described storage unit, devices, and programs without departing from the scope of the invention. The invention is thus not limited to the examples provided.

In particular, the storage unit is a single-sided optical disc having a single layer in the above-described embodiment. The spiral is read from the centre to the periphery.

The information zone comprises a single set of lead-in zone/data zone/lead-out zone.

If the storage medium has a plurality of layers or a plurality of sets of lead-in/data/lead-out zones, it is possible to have a single reserved area for all layers or sets. It is also possible to have a reserved area for each layer or set.

The word “comprising” does not exclude the presence of other elements or steps than those listed in the claims.

1. A storage medium storing data organized in files complying with a file system usable under an operating system, said data including file system data and application data, said application data being intended to be used by an application, part of said application data being needed for starting said application, said storage medium having a reserved area for storing data to be read and cached when the storage medium is declared to said operating system, said reserved area including at least said file system data and said application data needed for starting the application.

2. A storage medium as claimed in claim 1, wherein data are stored along a spiral having an inner part and an outer part, and said reserved area is located in said outer part.

3. A storage medium as claimed in claim 1, wherein data are stored along a spiral having an inner part and an outer part, and an anchor designating the location of said reserved area is stored in said inner part.

4. A storage medium as claimed in claim 3, wherein said reserved area has a size that is stored together with said anchor in said inner part.

5. A device for executing an application by reading application data stored on a storage medium as claimed in claim 1, said device having an operating system and being designed for reading and caching the data contained in the reserved area of said storage medium when said storage medium is declared to said operating system.

6. A device for writing a file on a storage medium as claimed in claim 1, wherein the file system defines a category of files to be allocated to said reserved area if possible, said device being designed for identifying files belonging to said category of files, and for trying to allocate such files to said reserved area.

7. A method of manufacturing a storage medium comprising the steps of:
providing data organized in files complying with a file system usable under an operating system, said data including file system data and application data, said application data being intended to be used by an application, part of said application data being needed for starting said application,
writing the provided data on said storage medium, said file system data and said application data needed for starting the application being written in a reserved area of said storage medium, said reserved area being intended to be read and cached when the storage medium is declared to said operating system.

8. A file system implementation program for implementing a file system, said file system being usable under an operating system in an apparatus for reading and/or writing data from/into a storage medium declared to said operating system, said file system defining the organization of data on said storage medium and notably a category of files to be allocated to a reserved area of said storage medium if possible, said file system implementation program comprising instructions for identifying files belonging to said category, and for trying to allocate such files to said reserved area when writing a file onto said storage medium.

9. An apparatus comprising memory means for storing and executing an operating system and a file system implementation program implementing a file system usable under said operating system, and means for writing data onto a storage medium declared to said operating system under the control of said computer program,
said file system defining the organization of data on said storage medium, said file system notably defining a category of files to be allocated to a reserved area of said storage medium if possible, said file system implementation program comprising instructions for identifying files belonging to said category, and for trying to allocate such files to said reserved area when writing a file onto said storage medium.

10. An application program having instructions for generating an application file intended to be used by an application, said application file being compliant with a file system usable under an operating system in an apparatus for writing data onto a storage medium declared to said operating system, said file system defining the organization of data on said storage medium and notably a category of files to be allocated to a reserved area of said storage medium if possible, said application file being intended to be written on said storage medium, said application program being designed for assigning said application file to said category of files if said application file is needed for starting said application.

11. An apparatus comprising memory means for storing a computer program as claimed in claim 10 and processing means for executing said application program.
